(19) United States
(12) Patent Application Publication
(10) Pub. No.: US 2021/0279777 A1
(43) Pub. Date: Sep. 9, 2021

(54) SYSTEM AND METHOD FOR PROVIDING CARBON OFFSETS

(71) Applicant: RARE, INC., Arlington, VA (US)

(72) Inventors: BRETT JENKS, Arlington, VA (US); TAMAR MAKOV, Binyamina (IL)

(21) Appl. No.: 16/808,037

(22) Filed: Mar. 3, 2020

(51) Int. Cl. G06Q 30/02; G06Q 20/14; G06Q 30/06; G06Q 20/10

(52) U.S. Cl. CPC G06Q 30/0283; G06Q 20/102; G06Q 30/0631; G06Q 20/145

(57) ABSTRACT

Systems and methods for providing carbon offsets are described, including monitoring a consumer's transactions, determining the full life cycle of greenhouse gas emissions associated with the consumer's transactions, and providing the consumer with carbon offsets to compensate for the consumer's carbon footprint.

### FIELD OF THE INVENTION

The present invention relates to systems and methods for monitoring a consumer's transactions, determining the carbon footprint associated with the consumer's transactions, providing the consumer with carbon offsets to compensate for the consumer's carbon footprint, and offering assistance with other financial decisions that reduce the consumer's carbon footprint.

### BACKGROUND

A significant portion of an individual's activity that contributes to the release of carbon dioxide or other greenhouse gases, i.e., the individual's carbon footprint, may be attributed to that individual's actions as a consumer. For example, when a consumer purchases manufactured goods, or transportation services, manufacturing those goods and providing those transportation services have an impact on the emission of greenhouse gases. However, many individual consumers do not have significant insight into the size of their carbon footprint, nor are they familiar with the various factors that affect the size of their carbon footprint. Consumers might not be aware of the relative contribution each of their purchases makes to their overall carbon footprint and might not know of opportunities to reduce their impacts, or offset them.

Further, greenhouse gas calculations or life cycle assessments for a given product or service are typically presented in terms of the process of manufacturing, distribution, use, and end-of-life or recycling of materials, which describe the quantity of, e.g., fossil fuels, plastics and other fossil fuel-based materials, or carbon dioxide or other greenhouse gases that are associated with that product or service. For consumers, these quantities may not be useful or actionable, and may not appropriately reflect the consumer's opportunity to reduce or offset their footprint.

Carbon offsets refer to efforts to reduce the emission of, or to increase the recapture of, greenhouse gases to compensate for the emission of greenhouse gases occurring elsewhere. For example, a person may seek to offset the greenhouse gas emissions associated with an airplane flight by giving money to organizations working to plant trees or conserve forests, that would not have been planted or conserved without this money. To drive the reduction and offset of individual carbon footprints, there is a need for systems and methods for analyzing a consumer's activity, estimating the associated carbon footprint, and presenting the consumer with an actionable opportunity to offset their carbon footprint.

### SUMMARY

Systems and methods for providing carbon offsets are described below. Providing succinct, direct, and actionable information regarding a user's carbon footprint helps to spur that user to act on the information, for example, to offset their carbon footprint by contributing to projects for reducing emissions or recapturing greenhouse gases. In an example embodiment of the present invention, carbon footprint information may be determined from a consumer's financial information. The carbon footprint information may then be presented to the consumer, for example, along with the consumer's financial information, such as a bank statement or credit card statement. The consumer may also be provided with a mechanism for acquiring carbon offsets to address the carbon footprint information, as described herein.

While the terms “carbon offset,” “carbon footprint,” and the like, are used herein, such terms are intended to refer to any category of greenhouse gas emissions, including carbon dioxide or carbon dioxide equivalents of other greenhouse gases. Further, the term “carbon footprint,” as used herein with reference to a service or product purchased, is intended to include any category of greenhouse gas emissions, including carbon dioxide or carbon dioxide equivalents of other greenhouse gases, associated with the full lifecycle or the service or product purchased.

In an exemplary embodiment of the present invention, a method for providing an offset for greenhouse gas emissions, may comprise receiving one or more emissions factors, each emissions factor associated with an economic sector, wherein each emissions factor represents a quantity of greenhouse gas emissions for each monetary unit spent in the associated economic sector, receiving one or more transaction categories for categorizing consumer purchases, each of the one or more transaction categories associated with one or more economic sectors, storing information describing one or more greenhouse gas offsetting projects, including a price for offsetting a unit of greenhouse gas emissions, and receiving one or more transactions associated with a consumer, including, for each of the one or more transactions, monetary expenditure and transaction category. The method may further comprise, for each of the one or more transactions, identifying the monetary expenditure, identifying the transaction category, comparing the transaction category to the stored transaction categories to identify the economic sector associated with the transaction category, applying the emissions factor associated with the identified economic sector to the identified monetary expenditure, to determine the amount of greenhouse gas emissions attributable to the transaction, and determining a price for offsetting greenhouse gas emissions attributable to the transaction, based on the amount of greenhouse gas emissions attributable to the transaction and the price for offsetting a unit of greenhouse gas emissions. The method may further comprise transmitting, to a user device, a carbon offset signal, including the price for offsetting greenhouse gas emissions attributable to each transaction, the one or more greenhouse gas offsetting projects, and payment processing information for contributing to the one or more greenhouse gas offsetting projects.

The method may further comprise, in response to the payment processing information, receiving payment for contributing to the one or more greenhouse gas offsetting project. The method may further comprise distributing the received payment to the one or more greenhouse gas offsetting projects.

The method may further comprise receiving login credentials associated with the consumer, and submitting the login credentials to a financial institution to receive one or more transactions associated with the consumer.

The method may further comprise receiving one or more retailer emissions factors, each retail emissions factor associated with a retailer, wherein each retailer emissions factor represents a quantity of greenhouse gas emissions for each monetary unit spent by consumers in the associated retailer.

The method may further comprise updating the stored information describing the one or more greenhouse gas offsetting projects, including an updated price for offsetting a unit of greenhouse gas emissions.

The method may further comprise, for each of the one or more transactions, adjusting the monetary expenditure to remove amounts not associated with the consumer's carbon footprint. The adjusting of the monetary expenditure to remove amounts not associated with the consumer's carbon footprint may comprise removing government taxes, and/or adjusting the monetary expenditures to reflect inflation.

In an exemplary embodiment of the present invention, a system for providing an offset for greenhouse gas emissions, may comprise a computer hardware arrangement configured to receive one or more emissions factors, each emissions factor associated with an economic sector, wherein each emissions factor represents a quantity of greenhouse gas emissions for each monetary unit spent in the associated economic sector, receive one or more transaction categories for categorizing consumer purchases, each of the one or more transaction categories associated with one or more economic sectors, store information describing one or more greenhouse gas offsetting projects, including a price for offsetting a unit of greenhouse gas emissions, and receive one or more transactions associated with a consumer, including, for each of the one or more transactions, monetary expenditure and transaction category. The computer hardware arrangement may further be configured to, for each of the one or more transactions, identify the monetary expenditure, identify the transaction category, compare the transaction category to the stored transaction categories to identify the economic sector associated with the transaction category, apply the emissions factor associated with the identified economic sector to the identified monetary expenditure, to determine the amount of greenhouse gas emissions attributable to the transaction; and determine a price for offsetting greenhouse gas emissions attributable to the transaction, based on the amount of greenhouse gas emissions attributable to the transaction and the price for offsetting a unit of greenhouse gas emissions. The computer hardware arrangement may further be configured to transmit, to a user device, a carbon offset signal, including the price for offsetting greenhouse gas emissions attributable to each transaction, the one or more greenhouse gas offsetting projects, and payment processing information for contributing to the one or more greenhouse gas offsetting projects.

The computer hardware arrangement may further be configured to, in response to the payment processing information, receive payment for contributing to the one or more greenhouse gas offsetting project. The computer hardware arrangement may further be configured to distribute the received payment to the one or more greenhouse gas offsetting projects.

The computer hardware arrangement may further be configured to receive login credentials associated with the consumer, and submit the login credentials to a financial institution to receive one or more transactions associated with the consumer.

The computer hardware arrangement may further be configured to receive one or more retailer emissions factors, each retail emissions factor associated with a retailer or retailer group, wherein each retailer emissions factor represents a quantity of greenhouse gas emissions for each monetary unit spent by consumers in the associated retailer.

The computer hardware arrangement may further be configured to update the stored information describing the one or more greenhouse gas offsetting projects, including an updated price for offsetting a unit of greenhouse gas emissions.

In an exemplary embodiment of the present invention, a method for providing an offset for greenhouse gas emissions, may comprise transmitting, from a user device, user login credentials for accessing a consumer's financial statement, receiving, at the user device, the financial statement including one or more transactions, displaying, on the user device, a selectable icon for initiating a determination of greenhouse gas emissions attributable to the one or more transactions, transmitting, from the user device, a request for the determination of greenhouse gas emissions attributable to the one or more transactions, receiving, at the user device, for each transaction, the determined greenhouse gas emissions attributable to the one or more transactions, and receiving, at the user device, a carbon offset signal, including a price for offsetting greenhouse gas emissions attributable to each transaction, one or more greenhouse gas offsetting projects, and payment processing information for contributing to the one or more greenhouse gas offsetting projects.

The method may further comprise, in response to the payment processing information, transmitting payment instructions for contributing to the one or more greenhouse gas offsetting projects. The payment instructions may specify the one or more greenhouse gas offsetting projects to receive payment, or the payment instructions may not specify the one or more greenhouse gas offsetting projects to receive payment.

The systems and methods described herein provide comprehensive, personalized carbon footprint information to a consumer in a place and manner in which that consumer may consider the information, and act on the information. The carbon footprint information may be securely held with the consumer's private financial information, both maintaining confidentiality and making it simple to contribute financially to carbon offsets.

### BRIEF DESCRIPTION OF THE DRAWINGS

FIG. 1 is an illustration of a product life cycle and environmental impacts thereof, in accordance with an example embodiment of the present invention.

FIG. 2 is a flowchart illustrating a method for providing carbon offsets, in accordance with an example embodiment of the present invention.

FIG. 3 is a flowchart illustrating a method for providing carbon offsets, in accordance with an example embodiment of the present invention.

FIG. 4 is an illustration of a user interface for providing carbon offsets, in accordance with an example embodiment of the present invention.

FIG. 5 is an illustration of a user interface for providing carbon offsets, in accordance with an example embodiment of the present invention.

FIG. 6 is an illustration of a user interface for providing carbon offsets, in accordance with an example embodiment of the present invention.

### DETAILED DESCRIPTION

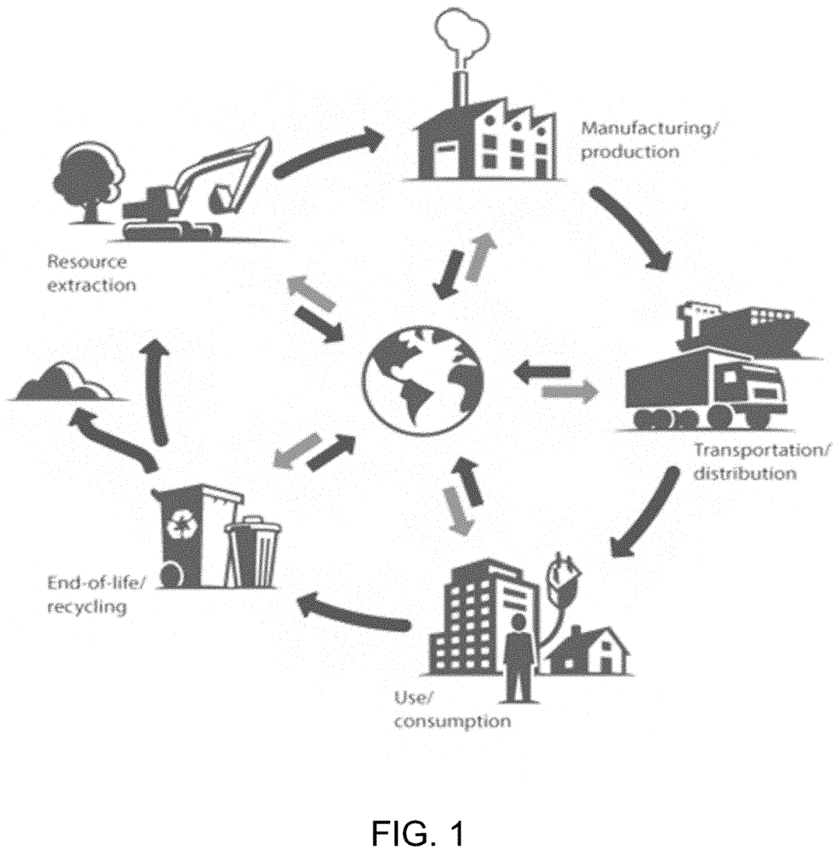

To effectively provide carbon footprint information, a consumer's spending may be used to quantify the greenhouse gas emissions associated with the full lifecycle of products and services purchased by a consumer. This may be done using economic analyses of transactions, consumption, and production associated with various industries. These economic analyses result from monitoring money as it flows through a supply chain for a given product or service, yielding a corresponding emissions factor for each unit of money spent in a given economic sector, representing the greenhouse gas emissions associated with each unit of money spent. As illustrated in FIG. 1, an exemplary input-output life cycle analysis may associate a given product with the value of fossil fuels extracted for that product (i.e., resource extraction), the value of materials produced in manufacture, the value of transportation and distribution of the product, the value of the use of the product, and the value of end of life disposal of the product. The life cycle of a product may be analyzed in these financial terms, instead of a process-based analysis focused on tracking materials and energy consumption in a supply chain. This allows for the association of a financial value to the various stages of a product's life cycle, and therefore a more comprehensive analysis across a wider variety of economic sectors. Financial terms can be translated to economic sectors where the “product” is a service, or otherwise lacks a physical product, such as banking, medicine, education, or the like. This also allows for improved internal consistency across products, and may be easily translated to the finances of a particular consumer, as described herein.

An example of this correlation between consumer spending and greenhouse gas emissions may be found in environmentally-extended input-output (EEIO) tables. EEIO tables connect the use of environmental resources to consumer spending, for various economic sectors. For each economic sector, the inputs (e.g., the cost of materials) and the environmental impacts are quantified in financial terms, and the revenues for that sector are identified. After a comparison, the analysis results in an emissions factor for each monetary unit spent in that economic sector, representing the greenhouse gas emissions associated with each monetary unit. In some instances, such tables may be prepared by government organizations. For example, the United States Environmental Protection Agency prepares United States Environmentally-Extended Input-Output (USEEIO) tables using economic modeling based on United States industry census data collected every five years, to describe the environmental impact of nearly 400 industry sectors. The emissions factor may be described as a unit of greenhouse gas per monetary unit, such as kgCO₂e/$USD (kilograms of carbon dioxide equivalent per U.S. dollar). By applying the emissions factor for a given economic sector to an amount of money spent by a consumer in that sector, it is possible to determine an amount of greenhouse gas emissions that is attributable to that transaction.

Some economic sectors may have emissions factors that vary by geographic region. For example, economic sectors relating to energy, such as oil, fuel, gasoline, electricity, and the like, may account for variances in the costs and environmental impact of those sectors in a particular geographic area. For example, if gasoline is relatively inexpensive in Geographic Region A, as compared to Geographic Region B, one dollar spent on gasoline in Geographic Region A purchases a greater amount of gasoline than would one dollar spent on gasoline in Geographic Region B, and accordingly may have a higher impact on greenhouse gas emissions than one dollar spent on gasoline in a Geographic Region B. Different energy costs and impacts may be segmented geographically, for example, by zip codes, so that the energy sector in each geographic region may have an emissions factor that reflects this geographic distinction. The calculation may also take into account differing sales tax rates across geographies and removes them from the calculation to improve accuracy.

For large retailers selling products across many economic sectors, detailed purchasing information may not be available in a consumer's financial statement, and therefore the particular economic sector of the purchase may not be available. For example, if the retailer sells groceries, clothing, travel services, and gasoline, the consumer's financial statement may not reflect the particular goods or services purchased, so that the relevant economic sector (and associated emissions factor) may not be determined. In such cases, an emissions factor specific to a particular retailer or retailer category (e.g., supermarkets) may be generated by calculating a weighted average of all of the economic sectors represented in the products purchased from that retailer. As used herein, the term “economic sector” may be used to refer to these types of mock economic sectors associated with, e.g., a particular retailer or other group of retailers that do not otherwise directly match an economic sector.

Significantly, this method may include the entire supply chain from raw material extraction, through end of life management, as well as any services purchased by the manufacturers during production. For example, the emissions factor for apparel may include not only the production and transport of the clothes, but also cloud computing services used by companies, as well as air travel for executives. Similarly, the factors for personal transport, such as ride sharing, taxi or gasoline purchases, may include not only fuel costs, but also the embodied cost of the vehicle's production, maintenance, as well as civil infrastructure, i.e., roads and lighting.

Statistically speaking, the emissions factor can then be applied to any consumer spending at that retailer without great need to identify the particular goods or services purchased by the consumer. The accuracy of the emissions factor for an individual purchase may not be paramount, and instead may be directionally correct, with accuracy increasing over time as many transactions are aggregated.

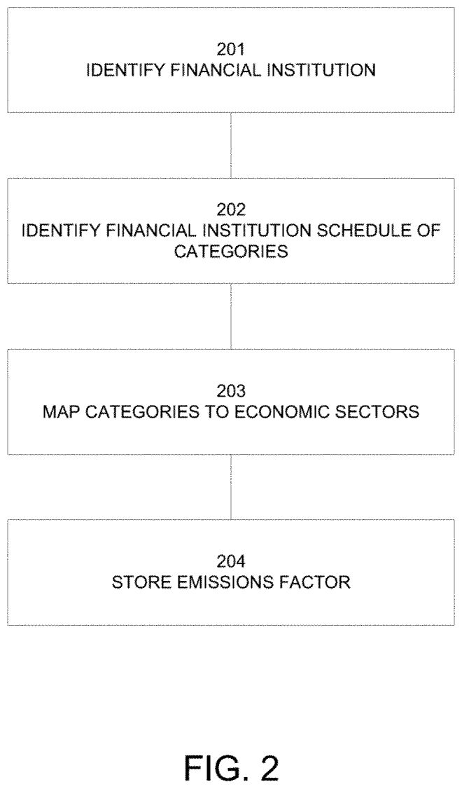

To provide carbon footprint information to consumers based on their bank statement or credit card statement, the consumer's banking institution may submit to an onboarding process, to have the bank's financial statements aligned with the economic sectors and associated emissions factors. An exemplary embodiment of the financial institution onboarding process is illustrated in FIG. 2. In Step 201, the financial institution is identified, as well as the financial service that monitors consumer purchases, such as a credit account, checking account, debit account, or the like. In Step 202, it is determined whether the financial institution applies a schedule of their own economic sectors or categories to consumer purchases. If so, in Step 203, the financial institution's schedule of consumer purchase categories is compared with, and mapped to, the economic sectors for which emissions factors are available, so that the emissions factors may be readily applied to the financial institution's schedule of consumer purchase categories. For example, if a financial institution includes a category for “clothing,” a consumer purchase fitting into this category may likewise fit into an economic sector for the garment industry. The mapping process may therefore associate purchases in the “clothing” category with the “garment industry” economic sector.

The financial institution's schedule of consumer purchase categories may outnumber the economics sectors for which emissions factors are available, and may also be organized in a different way. For example, the financial institution may have several hundred or even thousands of categories, organized into a hierarchical “tree” structure, in which broad categories include narrowing subcategories. In such circumstances, the hierarchical structure of the financial institution's schedule of consumer purchase categories may be mapped to the economic sectors, for example, by first comparing the more narrow consumer purchase subcategory with the economic sectors to find an economic sector which applies directly to the narrow consumer purchase subcategory. Then, if there is a sufficient match, the same comparison may be made for the next higher (i.e., broader) level of consumer purchase subcategory. If the broader subcategory also finds a sufficient match to an economic sector, the same comparison may be made for the yet next higher (i.e., broader) level of consumer purchase subcategory, and so on, until the broadest matching subcategory has been determined. For example, a purchase related to airline services may be assigned, by a financial institution, a consumer purchase category relating to travel and entertainment, a more narrow category relating to air travel, and a yet narrower category for a specific airline. In that example, the narrowest subcategory for the specific airline may fall within an economic sector associated with air travel, as would the broader air travel subcategory, while the yet broader travel and entertainment category would not map directly onto the air travel economic sector. This approach may be repeated for each consumer purchase category provided by a particular financial institution, and the mapping may then be stored for later use.

Having mapped the financial institution categories to the economic sectors, in Step 204 the relevant emissions factor associated with, e.g., $1 in purchaser prices in each economic sector can then be stored for each financial institution category. Alternatively, the financial institution may adapt a schedule of categories that already matches with the economic sectors for which emissions factors have been determined. For example, many banks use Visa Merchant Category Codes, an industry standard.

The next stage may include contact with individual consumers, or with a consumer's financial statement. A consumer having an account with the financial institution may be offered to enroll in the carbon footprint calculator and carbon offset provider, and, if they choose, may permit access to their financial statement. This may be achieved by an application program interface (API), which may communicate with the consumer's financial statement via a web service or mobile application. Once access has been granted, the financial statement may be analyzed item by item, a carbon footprint may be determined, and a carbon offset may be offered. For example, to calculate the carbon footprint for a particular month, all the transactions and purchases for that month would be analyzed individually, where the financial institution category for each transaction may be mapped to the most relevant industry sector, thus obtaining the emissions factor for that transaction. Multiplying the value of the transaction with the emissions factor would yield the carbon footprint associated with the transaction, and repeating this process for all transactions that occurred in the month and adding them up would yield the consumer's carbon footprint for the month.

To provide a carbon offset, a price for each offset carbon unit may be determined. A unit of carbon offset may be described, for example, as a quantity of greenhouse gas emissions, which will be offset by an offsetting activity. The cost of a unit of carbon to be offset may depend on various factors, including the available carbon offsetting projects available at a given time, and therefore may vary. A carbon offset unit may be priced by identifying one or more available carbon offsetting projects. Such projects may include any project that works to reduce, eliminate, or prevent the emission of, some quantity of greenhouse gases. Examples include projects for building renewable energy infrastructure, building waste management infrastructure, planting trees, limiting deforestation, replacing energy-inefficient systems with energy-efficient systems, and the like. Once the available carbon offsetting projects are known, each project may have an identified quantity of greenhouse gas emissions that will be reduced or eliminated by that project. By comparing this quantity to the cost of the project, a price per unit of carbon offset may be determined. If a plurality of carbon offsetting projects are available, this price may be blended across all available projects. For example, the total quantity of greenhouse gas emissions that will be reduced or eliminated by the plurality of projects may be compared to the total cost of those projects, so that a price per unit of carbon offset may be determined for the plurality of projects. Such a blended cost may be advantageous for providing carbon offsetting opportunities to a large number of consumers, as certain carbon offsetting projects may be completed or otherwise become unavailable, and those carbon offsets may instead be applied to another project. The purchases of carbon offsets may be managed in a distributed or diversified manner, if the consumer is willing to contribute financially to carbon offsets generally, without concern for the particular project or application to receive the investment.

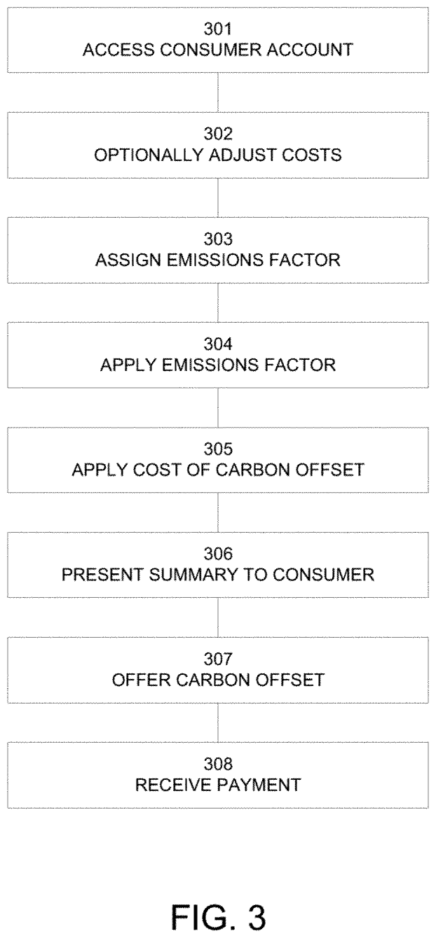

An exemplary embodiment of the present invention is illustrated in FIG. 3. At Step 301, an API accesses a consumer bank account, credit or debit account, financial statement, or other similar account of transactions made by the consumer. In an exemplary embodiment, the financial institution may present, to the consumer, an option to have their carbon footprint calculated for the purchases on the consumer's financial statement. In such an embodiment, when the consumer presents their credentials to log into the financial institution's website or mobile service, the website or mobile service may include an integrated plugin to present a selectable icon to the consumer, offering the carbon footprint calculation services. If the consumer selects the icon, the API is initiated. Alternatively, or in addition, the API may be initiated automatically, for example, when the consumer logs in. Alternatively, or in addition, the API may be initiated at regularly scheduled intervals, e.g., daily, weekly, or monthly, or at certain times of day, such that the results of the carbon footprint process are presented to the consumer without an explicit command from the consumer.

In an exemplary embodiment, the financial institution may integrate the API into the financial institution's processes for providing the consumer with their financial information online. This embodiment has the advantage of readily providing carbon footprint information as part of the services regularly access by the consumer. Alternatively, the consumer may initiate the API from a third party, outside of the financial institution's website or mobile service. In such an embodiment, for example, the consumer may provide their credentials to the third party service. The third party service may then use the credentials to access the consumer's financial statement. This embodiment has the advantage of operating independently of any particular financial institution.

In an exemplary embodiment, once the API is initiated, the information contained in the financial statement, including purchase information, may be copied and stored in a database in a server remote from the computing systems operated by the financial institution. Alternatively, the API may apply the following processes to the purchase information contained in the financial statement as it is maintained by the financial institution.

Once the list of consumer transactions has been obtained, this purchase information may optionally, at Step 302, be adjusted to account for certain costs that may have little or no association with the consumer's carbon footprint. For example, estimated taxes paid by the consumer in a given purchase may be removed, or the numbers may be adjusted for inflation, to reflect the value of money at the time of the transaction as compared to the value of money at the time that the emissions factors had been calculated.

Then, at Step 303, the amount of each transaction in the financial statement may be pulled, and assigned an emissions factor. If the financial institution has already undergone the onboarding process, this may be achieved by comparing the category for the transaction to the mapped economic sector previously stored on the server. If not, the transaction category may be mapped to the relevant economic sector at this time, and the associated emissions factor may be identified. The emissions factor may be described as a unit of greenhouse gas per unit of money, such as kgCO₂e/$USD (kilograms of carbon dioxide equivalent per U.S. dollar). At Step 304, by applying the emissions factor for a given economic sector to an amount of money spent by a consumer in that sector, it is possible to determine an amount of greenhouse gas emissions that is attributable to that transaction. This step may be repeated for any number of transactions in the financial statement. For example, the process may be applied to transactions posted over a certain period of time, such as a month or a year, so that a cumulative carbon footprint attributable to transactions over that period of time may be determined. At Step 305, the carbon footprint may be compared to the price per unit of carbon offset associated with available carbon offset projects, yielding a price for carbon offsets sufficient to compensate for the determined carbon footprint.

At Step 306, a summary of the determination of the carbon offsets sufficient to compensate for the determined carbon footprint may be presented to the consumer. The summary may highlight the carbon footprint and associated carbon offset costs associated with each transaction. The summary may highlight the carbon footprint and associated carbon offset costs associated with a collection of transactions, for example, over a month or a year. The summary may highlight particular transactions or economic sectors in which the consumer has the greatest carbon footprint, and may sort the transactions by their impact on the consumer's carbon footprint, either in total or on a per-dollar basis. The summary may present the carbon footprint information in charts or diagrams to convey which areas have the greatest impact on the consumer's carbon footprint. The summary may highlight trends in the consumer's carbon footprint, such as changes in the consumer's carbon footprint over time, or in certain economic sectors. The summary may be presented within the consumer's monthly financial statement, or may be presented to the consumer when the consumer accesses their financial statement via a website or mobile application. The summary may also, or, as an alternative, be presented to consumer independent of their financial statement.

At Step 307, the consumer may be presented with an opportunity to purchase carbon offsets sufficient to compensate for the determined carbon footprint. In a consumer's financial statement, as presented on a financial institution's website or mobile application, the offer may be presented with a mechanism for the consumer to submit payment for the carbon offset, such as a link to a payment processing system. This may include a description of particular available carbon offset projects, and may include an indication that the carbon offset payment may be applied broadly to various carbon offset projects, which may otherwise have different costs per unit of carbon offset. There are advantages to reducing the complexity shown to the consumer, who may prefer to see a blended carbon offset rate generally applicable to a variety of available carbon offset projects. In the alternative, there may be advantages to providing the consumer with specific projects, so that the consumer can choose those projects of particular interest, or greatest impact.

At Step 308, the payment processing system may receive a payment from the consumer, to be applied to the carbon offset. The payment may be applied against the consumer's account, in the same manner as any of the other transactions appearing on the account. The received payment may then be distributed to one or more carbon offset projects.

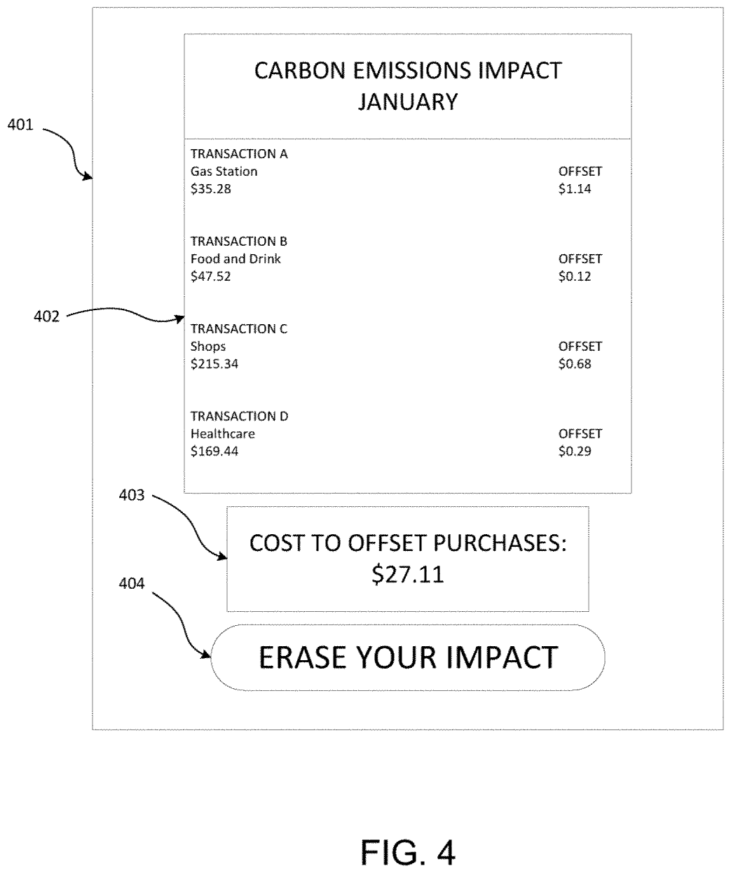

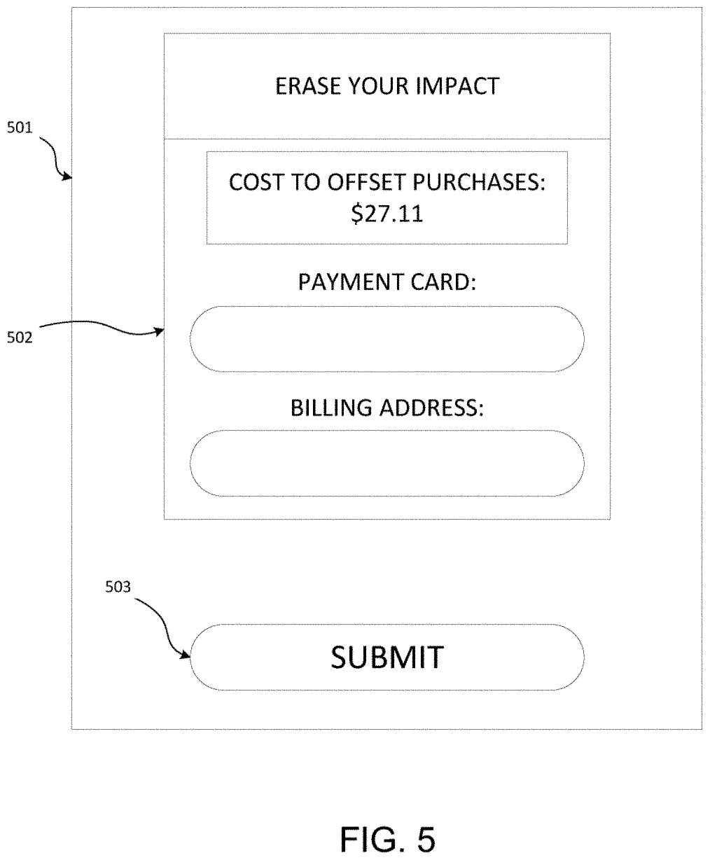

An exemplary summary of the determination of the carbon offsets sufficient to compensate for the determined carbon footprint, according to an exemplary embodiment of the present invention, is illustrated in FIG. 4. As shown in FIG. 4, the consumer may be provided with a carbon emissions impact summary, for example, covering a month of transactions. Display 401 may be presented on a computer or mobile computing device, and may include transaction summary 402, offset summary 403, and a link to acquiring carbon offsets 404. As shown in FIG. 4, each transaction may be displayed with its respective economic sector, and with its respective carbon offset cost. Though not illustrated, transaction summary 402 may also include the determined carbon footprint for each transaction, for example, in kilograms of carbon dioxide equivalent. The total carbon offset cost for, e.g., a selected month, may be provided in the offset summary 403. Though not illustrated, offset summary 403 may also include the determined carbon footprint for the summed transactions, for example, in kilograms of carbon dioxide equivalent. Link 404 may be included to allow the consumer to navigate to a payment processing page. An exemplary embodiment of the payment processing page is illustrated in FIG. 5. Display 501 may include payment window 502, for receiving a consumer's payment information. The cost of the carbon offset may again be provided in the display 501. The consumer may enter payment information, and submit payment by selecting submission link 503. The consumer may then be charged the cost of the carbon offset.

In an exemplary embodiment of the present invention, the consumer may be provided with a link to publish the consumer's carbon footprint information, for example, to a social media platform, or to a selected group of the consumer's contacts. Further to such an embodiment, competitive games may be devised, for consumers to compete, e.g., for the lowest carbon footprint in a given time period.

In an exemplary embodiment of the present invention, a consumer may set a maximum carbon footprint for a given time period. As the consumer executes transactions on the account, the consumer's carbon footprint may be monitored. If the consumer's carbon footprint reaches the maximum carbon footprint for the given time period, the consumer may be blocked for executing further transactions. The consumer may be required to wait for the time period to end, or to acquire carbon offsets, before being permitted to execute further transactions.

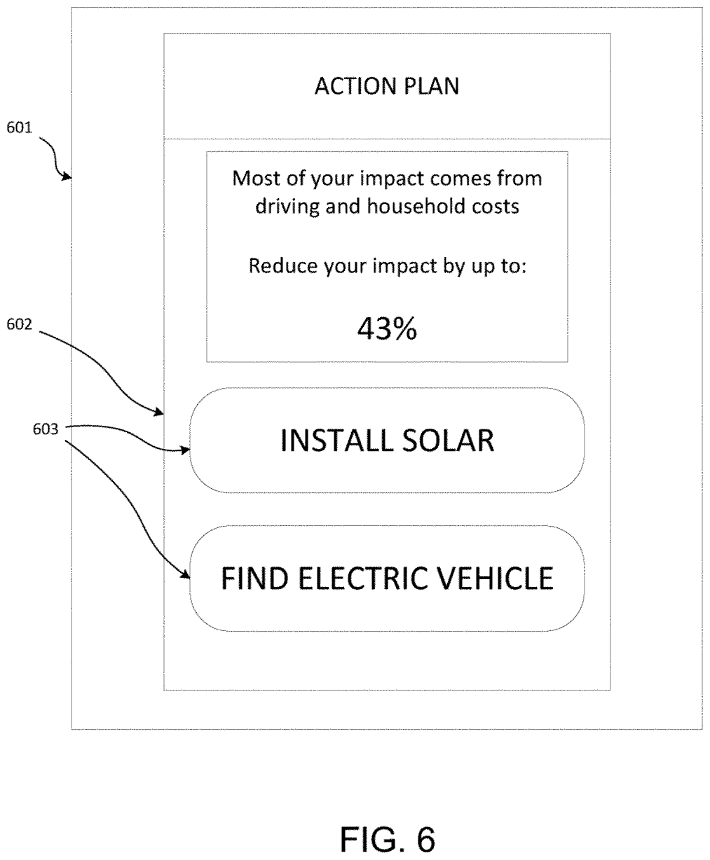

In an exemplary embodiment of the present invention, a consumer may be provided with potential alternative purchases that may reduce or otherwise offset the consumer's carbon footprint. For example, if the consumer's financial information includes purchases in economic sectors relating to electric utility bills, in a region in which energy is known to have a significant impact on carbon emissions (e.g., the energy is primarily sourced from fossil fuels), the consumer may be provided with selectable icons or other links to services for rooftop solar panel installations. In such an embodiment, a third party service may maintain a regularly updated database of solar installers in the relevant area, the costs associated with such installers, and the impact per dollar spent on a consumer's carbon footprint for that particular geographic area, determined as described above. Similarly, if, for example, the consumer's financial information includes purchases of gasoline, the consumer may be provided with selectable icons or other links to information offering guidance and decision assistance towards the purchase or lease of an electric vehicle. In such an embodiment, a third party service may maintain a regularly updated database of electric vehicles, the costs associated with owning such vehicles, and the impact per dollar spent on a consumer's carbon footprint, determined as described above. In this way, the carbon emissions calculator and associated decision support offerings will help the consumer make lifestyle decisions necessary for reducing their carbon footprint. An exemplary embodiment according to the present invention, including providing the consumer with potential alternative purchases, is illustrated in FIG. 6. Display 601 may be presented on a computer or mobile computing device, and may include action plan summary 602, and one or more links to alternative purchases 603.

In an exemplary embodiment of the present invention, information relating to a potential transaction may be analyzed prior to processing of the payment in the transaction, to provide the consumer with information relating to the impact of that potential transaction on the consumer's carbon footprint. A consumer may request advance notification of the carbon footprint of a product or service, which would be calculated, as described above, using the associated emissions factor.

By accessing a consumer's financial transactions, applying emissions factors based on the economic sector of the transactions, presenting the carbon footprint information to the consumer, and offering carbon offsets to address that footprint, as well as make changes in home energy, transportation, and diet, the present invention allows consumers to quickly and easily understand their carbon footprint, and act to neutralize it.

What is claimed is:

1. A method for providing an offset for greenhouse gas emissions, comprising:
receiving one or more emissions factors, each emissions factor associated with an economic sector, wherein each emissions factor represents a quantity of greenhouse gas emissions for each monetary unit spent in the associated economic sector;
receiving one or more transaction categories for categorizing consumer purchases, each of the one or more transaction categories associated with one or more economic sectors;
storing information describing one or more greenhouse gas offsetting projects, including a price for offsetting a unit of greenhouse gas emissions;
receiving one or more transactions associated with a consumer, including, for each of the one or more transactions, monetary expenditure and transaction category;
for each of the one or more transactions:
identifying the monetary expenditure;
identifying the transaction category;
comparing the transaction category to the stored transaction categories to identify the economic sector associated with the transaction category;
applying the emissions factor associated with the identified economic sector to the identified monetary expenditure, to determine the amount of greenhouse gas emissions attributable to the transaction; and
determining a price for offsetting greenhouse gas emissions attributable to the transaction, based on the amount of greenhouse gas emissions attributable to the transaction and the price for offsetting a unit of greenhouse gas emissions; and
transmitting, to a user device, a carbon offset signal, including the price for offsetting greenhouse gas emissions attributable to each transaction, the one or more greenhouse gas offsetting projects, and payment processing information for contributing to the one or more greenhouse gas offsetting projects.

2. The method according to claim 1, further comprising:
in response to the payment processing information, receiving payment for contributing to the one or more greenhouse gas offsetting project.

3. The method according to claim 2, further comprising:
distributing the received payment to the one or more greenhouse gas offsetting projects

4. The method according to claim 1, further comprising:
receiving login credentials associated with the consumer, and
submitting the login credentials to a financial institution to receive one or more transactions associated with the consumer.

5. The method according to claim 1, further comprising:
receiving one or more retailer emissions factors, each retail emissions factor associated with a retailer, wherein each retailer emissions factor represents a quantity of greenhouse gas emissions for each monetary unit spent by consumers in the associated retailer.

6. The method according to claim 1, further comprising:
updating the stored information describing the one or more greenhouse gas offsetting projects, including an updated price for offsetting a unit of greenhouse gas emissions.

7. The method according to claim 1, further comprising:
for each of the one or more transactions:
adjusting the monetary expenditure to remove amounts not associated with the consumer's carbon footprint.

8. The method according to claim 7, wherein the adjusting of the monetary expenditure to remove amounts not associated with the consumer's carbon footprint comprises removing government taxes.

9. The method according to claim 7, wherein the adjusting of the monetary expenditure to remove amounts not associated with the consumer's carbon footprint comprises adjusting the monetary expenditure to reflect inflation.

10. A system for providing an offset for greenhouse gas emissions, comprising:
a computer hardware arrangement configured to:
receive one or more emissions factors, each emissions factor associated with an economic sector, wherein each emissions factor represents a quantity of greenhouse gas emissions for each monetary unit spent in the associated economic sector;
receive one or more transaction categories for categorizing consumer purchases, each of the one or more transaction categories associated with one or more economic sectors;
store information describing one or more greenhouse gas offsetting projects, including a price for offsetting a unit of greenhouse gas emissions;
receive one or more transactions associated with a consumer, including, for each of the one or more transactions, monetary expenditure and transaction category;
for each of the one or more transactions:
identify the monetary expenditure;
identify the transaction category;
compare the transaction category to the stored transaction categories to identify the economic sector associated with the transaction category;
apply the emissions factor associated with the identified economic sector to the identified monetary expenditure, to determine the amount of greenhouse gas emissions attributable to the transaction; and
determine a price for offsetting greenhouse gas emissions attributable to the transaction, based on the amount of greenhouse gas emissions attributable to the transaction and the price for offsetting a unit of greenhouse gas emissions; and
transmit, to a user device, a carbon offset signal, including the price for offsetting greenhouse gas emissions attributable to each transaction, the one or more greenhouse gas offsetting projects, and payment processing information for contributing to the one or more greenhouse gas offsetting projects.

11. The system according to claim 10, wherein the computer hardware arrangement is further configured to:
in response to the payment processing information, receive payment for contributing to the one or more greenhouse gas offsetting project.

12. The system according to claim 11, wherein the computer hardware arrangement is further configured to:
distribute the received payment to the one or more greenhouse gas offsetting projects

13. The system according to claim 10, wherein the computer hardware arrangement is further configured to:
receive login credentials associated with the consumer; and
submit the login credentials to a financial institution to receive one or more transactions associated with the consumer.

14. The system according to claim 10, wherein the computer hardware arrangement is further configured to:
receive one or more retailer emissions factors, each retail emissions factor associated with a retailer or retailer group, wherein each retailer emissions factor represents a quantity of greenhouse gas emissions for each monetary unit spent by consumers in the associated retailer.

15. The system according to claim 10, wherein the computer hardware arrangement is further configured to:
update the stored information describing the one or more greenhouse gas offsetting projects, including an updated price for offsetting a unit of greenhouse gas emissions.

16. A method for providing an offset for greenhouse gas emissions, comprising:
transmitting, from a user device, user login credentials for accessing a consumer's financial statement;
receiving, at the user device, the financial statement including one or more transactions;
displaying, on the user device, a selectable icon for initiating a determination of greenhouse gas emissions attributable to the one or more transactions;
transmitting, from the user device, a request for the determination of greenhouse gas emissions attributable to the one or more transactions;
receiving, at the user device, for each transaction, the determined greenhouse gas emissions attributable to the one or more transactions; and
receiving, at the user device, a carbon offset signal, including a price for offsetting greenhouse gas emissions attributable to each transaction, one or more greenhouse gas offsetting projects, and payment processing information for contributing to the one or more greenhouse gas offsetting projects.

17. The method according to claim 16, further comprising:
in response to the payment processing information, transmitting payment instructions for contributing to the one or more greenhouse gas offsetting projects.

18. The method according to claim 17, wherein the payment instructions specify the one or more greenhouse gas offsetting projects to receive payment.

19. The method according to claim 17, wherein the payment instructions do not specify the one or more greenhouse gas offsetting projects to receive payment.
